(19) United States
(12) Patent Application Publication
(10) Pub. No.: US 2022/0405624 A1
(43) Pub. Date: Dec. 22, 2022

(54) LEARNING DEVICE, LEARNING METHOD, AND LEARNING PROGRAM

(71) Applicant: NIPPON TELEGRAPH AND TELEPHONE CORPORATION, Tokyo (JP)

(72) Inventors: Hiroshi TAKAHASHI, Musashino-shi, Tokyo (JP); Tomoharu IWATA, Musashino-shi, Tokyo (JP); Sekitoshi KANAI, Musashino-shi, Tokyo (JP); Atsutoshi KUMAGAI, Musashino-shi, Tokyo (JP); Yuki YAMANAKA, Musashino-shi, Tokyo (JP); Masanori YAMADA, Musashino-shi, Tokyo (JP); Satoshi YAGI, Musashino-shi, Tokyo (JP)

(73) Assignee: NIPPON TELEGRAPH AND TELEPHONE CORPORATION, Tokyo (JP)

(21) Appl. No.: 17/777,074

(22) PCT Filed: Nov. 21, 2019
(86) PCT No.: PCT/JP2019/045693

§ 371 Date: May 16, 2022

(51) Int. Cl. G06N 7/00; G06N 20/00

(52) U.S. Cl. CPC G06N 7/005; G06N 20/00

(57) ABSTRACT

An acquisition unit 15a acquires data in a task. The learning unit 15b learns a generation model representing a distribution of a probability of the data in the task so that a mutual information amount between a latent variable and an observed variable is minimized in the model.

### TECHNICAL FIELD

The present invention relates to a learning device, an estimation device, a learning method, and a learning program.

### BACKGROUND ART

A variational autoencoder (VAE) using a latent variable and a neural network to perform density estimation is known as a technology for estimating a probability distribution of data through machine learning (see NPL 1 to NPL 3). The VAE can estimate a probability distribution of large-scale and complicated data, and thus is applied to various fields such as abnormality detection, image recognition, moving image recognition, and voice recognition.

Meanwhile, it is known that a VAE of the related art requires a large amount of data for machine learning, and performance deteriorates when the amount of data is small. Thus, as a scheme for preparing a large amount of learning data, multitask learning in which data of other tasks is used to improve performance of density estimation of data of a target task is known. in the multitask learning, invariant features between tasks are learned and invariant knowledge between a target task and other tasks is shared, so that performance is improved. For example, with a conditional variational autoencoder (CVAE), a task-invariant prior distribution is assumed for a latent variable, so that dependency of the latent variable on a task can be reduced and task-invariant features can be learned.

### CITATION LIST

### Non Patent Literature

NPL 1: Diederik P. Kingma, et al., “Semi-supervised Learning with Deep Generative Models,” Advances in neural information processing systems, 2014, [Retrieved on Oct. 25, 2019], Internet <URL: http://papers.nips.cc/paper/5352-semi-supervised-learning-with-deep-generative-models.pdf>

NPL 2: Christos Louizos, et al., “The Variational Fair Autoencoder,” [online], arXiv preprint arXiv: 1511.00830, 2015, [Retrieved on Oct. 25, 2019], Internet <URL: https://arxiv.org/pdf/1511.00830.pdf>
NPL 3: Hiroshi Takahashi, et al., “Variational Autoencoder with Implicit Optimal Priors,” [online], Proceedings of the AAA,' Conference on Artificial Intelligence, Vol. 33, 2019, [Retrieved on Oct. 25, 2019], Internet <https://aaai.org/ojs/index.php/AAAI/article/view/443>

### SUMMARY OF THE INVENTION

### Technical Problem

However, in the CVAE, it is known that dependency of a latent variable on a task remains in many cases, and reduction of task dependency is insufficient. Thus, there is a problem that accuracy of multitask learning cannot be sufficiently improved in some cases.

The present invention has been made in view of the above, and an object of the present invention is to improve accuracy of multitask learning.

### Means for Solving the Problem

In order to solve the above-described problems and achieve the object, a learning device according to the present invention includes an acquisition unit configured to acquire data in a task; and a learning unit configured to learn a model representing a distribution of a probability that the data in the task is generated so that a mutual information amount between a latent variable and an observed variable is minimized in the model.

### Effects of the Invention

According to the present invention, it is possible to improve accuracy of multitask learning.

### BRIEF DESCRIPTION OF DRAWINGS

FIG. 1 is an illustrative diagram illustrating an overview of a learning device.

FIG. 2 is an illustrative diagram illustrating an overview of the learning device.

FIG. 3 is a schematic diagram illustrating a schematic configuration of the learning device.

FIG. 4 is an illustrative diagram illustrating processing of the learning unit.

FIG. 5 is a schematic diagram illustrating a schematic configuration of an estimation device.

FIG. 6 is an illustrative diagram illustrating processing of a detection unit.

FIG. 7 is an illustrative diagram illustrating processing of the detection unit.

FIG. 8 is a flowchart illustrating a learning processing procedure.

FIG. 9 is a flowchart illustrating an estimation processing procedure.

FIG. 10 is a diagram illustrating a computer that executes a learning program or an estimation program.

### DESCRIPTION OF EMBODIMENTS

Hereinafter, an embodiment of the present invention will be described in detail with reference to the drawings. The present invention is not limited to the embodiment. Further, in description of the drawings, the same parts are denoted by the same reference signs.

Overview of Learning Device

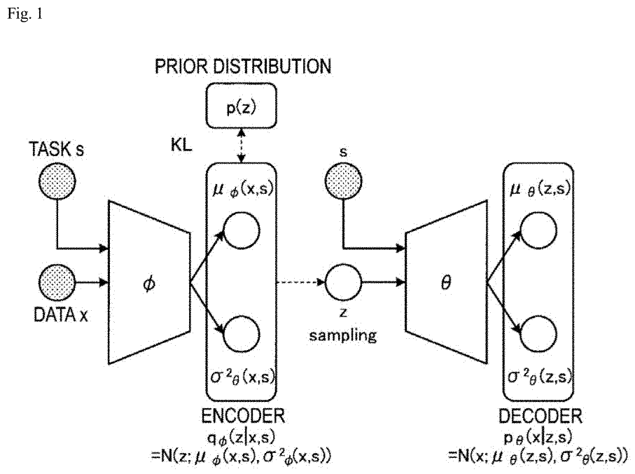

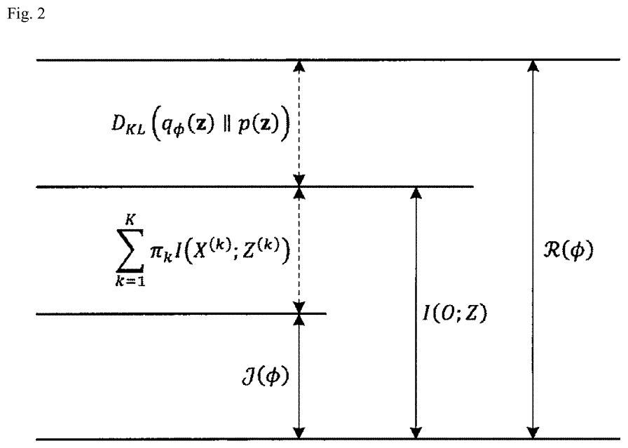

A learning device of the present embodiment creates a generation model based on a CVAE and performs task-invariant density estimation. Here, FIGS. 1 and 2 are illustrative diagrams illustrating an overview of the learning device. As illustrated in FIG. 1, the CVAE includes two conditional probability distributions called encoders and decoders.

The encoder q_{φ}(z|x, s) encodes data x in a task s to convert the data into a representation in which a latent variable z is used. Here, φ is a parameter of the encoder. Further, the decoder p_{θ}(x|z, s) decodes the data encoded by the encoder to reproduce the original data x in the task s. Here, θ is a parameter of the decoder. When the original data x is a continuous value, a Gaussian distribution is typically applied to the encoder and decoder. In the example illustrated in FIG. 1, a distribution of the encoder is N(z; μ_{φ}(x, s), σ²_{φ}(x, s)), and a distribution of the decoder is N(x; μ_{θ}(z, s), σ²_{θ}(z, s)).

Specifically, the CVAE estimates a probability p_{θ}(x, s) of the data x in the task s using the latent variable z, as expressed in Equation (1) below. Here, p(z) is called a prior distribution.

[Math. 1]

p_{θ}(x|s)=∫p_{θ}(x|z, s)p(z)dz . . . ()

In the CVAE learning, learning is performed so that the expected value of a variational lower bound L of 1np_{θ}(x|s) in Equation (2) below is maximized, and a parameter is determined,

$$\begin{matrix}[ Math . 2 ] & \\ ln {p}_{θ} ( x \vert s ) = ln {{q}_{θ} ( z \vert x , s )}_{} [ \frac{{p}_{θ} ( x \vert z , s ) p ( z )}{{q}_{θ} ( z \vert x , s )} ] \geq {{q}_{θ} ( z \vert x , s )}_{} [ ln \frac{{p}_{θ} ( x \vert z , s ) p ( z )}{{q}_{θ} ( z \vert x , s )} ] ≡ ℒ ( x , s ; θ , ϕ ) & ( 2 )\end{matrix}$$

Here, a first term of the variational lower bound L in Equation (3) below is called a reconstruction error (RE), and a second term is called a Kullback-Leibler information amount (KL),

[Math. 3]

[symbol]

(x,s;θ, ϕ)= [symbol] _{zϕ(z|x,s)}[1 np₇₄(x|z,s)]−D_{KL}(q_{ϕ}(z|x, s)||p(z)) . . . (3)

Specifically, in the CVAE, for a true joint distribution p_{D}(x, s) of the data x and the tasks, an expected value of the variational lower bound L is used as the objective function as expressed in Equation (4) below, and learning is performed so that the objective function is maximized.

[Math. 4]

[symbol]

_{CVAE}(θ, ϕ)= [symbol] _{pD(x,s)}[ [symbol] (x, s; θ, ϕ)] . . . (4)

Thus, in the CVAE, an expected value R(p) of KL of the CVAE in Equation (3) above is minimized, so that the expected value of the variational lower bound L is maximized. The expected value R(p) of KI of the CVAE is expressed by Equation (5) below.

[Math. 5]

$$\begin{matrix}[ Math . 5 ] & \\ ( ϕ ) ≡ {{p}_{D} ( x , s )}_{} [ {D}_{KL} ( {q}_{ϕ} ( z \vert x , s ) ‖ p ( z ) ) ] = I ( O ; Z ) + {D}_{KL} ( {q}_{ϕ} ( z ) ‖ p ( z ) ) & ( 5 )\end{matrix}$$

Here, I (O; Z) is a mutual information amount between the latent variable z and observed variables x and s, and is expressed by Equation (6) below.

$$\begin{matrix}[ Math . 6 ] & \\ I ( O ; Z ) = {E}_{{q}_{ϕ} ( z \vert x , s ) {p}_{D} ( x , s )} [ ln \frac{{q}_{ϕ} ( z \vert x , s )}{{q}_{ϕ} ( z )} ] & ( 6 )\end{matrix}$$

Further, when respective probabilities of K tasks are p_{D}(s=k)=πₖ, JS divergence in Equation (8) below is introduced in a posterior distribution of the latent variable z with respect to the task s in Equation (7) below.

[Math. 7]

q_{ϕ}(z|s)=∫q_{ϕ(z}1x, s)p_{D}(x|s)dx . . . (7)

$$\begin{matrix}[ Math . 8 ] & \\ ( ϕ ) ≡ {D}_{JS} ( q , ( z \vert s = 1 ) , … , {q}_{ϕ} ( z \vert s = K ) ) = {\sum }_{k = 1}^{K} {π}_{k} {D}_{KL} ( {q}_{ϕ} ( z \vert s = k ) ‖ {q}_{ϕ} ( z ) ) & ( 8 )\end{matrix}$$

Here, q_{ϕ}(z) is expressed by Equation (9) below.

$$\begin{matrix}[ Math . 9 ] & \\ {q}_{ϕ} ( z ) = {\sum }_{s} \int {q}_{ϕ} ( z \vert x , s ) {p}_{D} ( x , s ) dx & ( 9 )\end{matrix}$$

J(φ), which is the JS divergence in Equation (8) above, has a large value in a case in which the latent variable z depends on the task s, and a small value in a case in which the latent variable z does not depend on the task s. Thus, the JS divergence can be used as a measure of task dependency.

In the CVAE, the expected value R(φ) of KL of the CVAE in Equation (5) above is minimized. Because this J(φ) is curbed from above by R(φ), J(φ) is also minimized in the CVAE, so that the dependence of the latent variable z on the task s is reduced.

Here, FIG. 2 is a diagram illustrating a magnitude relationship among J(φ), R(φ), and I(O; Z). As illustrated in FIG. 2, R(φ) cannot be said to be a tight upper bound of J(φ), and J(φ) cannot be sufficiently minimized. Thus, in the CVAE, the task dependency cannot be sufficiently reduced.

Thus, the learning device of the present embodiment minimizes a mutual information amount I(O; Z). As illustrated in FIG. 2, because I(O; Z) is an upper bound of J(φ) that is tighter than R(φ), J(φ) becomes smaller when the mutual information amount I(O; Z) is minimized, so that the task dependency can be smaller.

Further, a difference between R(φ) and I(O; Z) in Equation (10) below derived from Equation (5) above becomes zero when p(z)=q_{φ}(z). That is. minimizing I(O; Z) instead of R(φ) is equivalent to changing a prior distribution P(z) to q_{φ}(z) in Equation (9) above.

[Math. 10]

[symbol]

(ϕ)−I(O; Z)=D _{KL}(q_{ϕ}(z)||p(z)) . . . (10)

This allows the learning device of the present embodiment to further reduce the task dependency as compared with CVAE and improve the accuracy of multitask learning.

Configuration of Learning Device

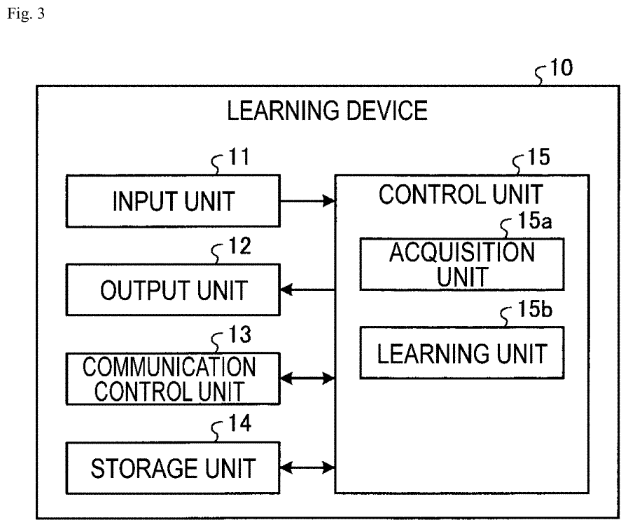

FIG. 3 is a schematic diagram illustrating a schematic configuration of the learning device. As illustrated in FIG. 3, the learning device 10 is achieved by a general-purpose computer such as a personal computer, and includes an input unit 11, an output unit 12, a communication control unit 13, a storage unit 14, and a control unit 15.

The input unit H is achieved by using an input device such as a keyboard or a mouse, and inputs various types of instruction information such as processing start to the control unit 15 in response to an input operation from an operator. The output unit 12 is achieved by a display device such as a liquid crystal display, a printing device such as a printer, or the like.

The communication control unit 13 is achieved by a network interface card (NIC) or the like, and controls communication between an external device connected via a network 3, such as a server, and the control unit 15. For example, the communication control unit 13 controls communication between a management device or the like that manages various types of information and the control unit 15.

The storage unit 14 is achieved by a semiconductor memory element such as a random access memory (RAM) or a flash memory, or a storage device such as a hard disk or an optical disc, and stores, for example, a parameter of a data generation model learned through learning processing to be described below. The storage unit 14 may be configured to communicate with the control unit 15 via the communication control unit 13.

The control unit 15 is achieved by using a central processing unit (CPU) or the like, and executes a processing program stored in a memory. This allows the control unit 15 to function as an acquisition unit 15a and a learning unit 15b, as illustrated in FIG. 3. These functional units may be implemented in different hardware. Further, the control unit 15 may include other functional units. For example, the control unit 15 can include a functional unit of the estimation device 20 to be described below and operate as the estimation device 20.

The acquisition unit 15a. acquires the data in the task. For example, the acquisition unit 15a acquires, for each task, sensor data output by a sensor attached to an IoT device via the communication control unit 13. Examples of the sensor data include data of sensors for temperature, speed, rotation speed, traveling distance, and the like attached to a car, and data of sensors for temperature, frequency, sound, and the like attached to a wide variety of devices operating in a factory. Further, the acquisition unit 15a may store the acquired data in the storage unit 14. The acquisition unit 15a may transfer such information to the learning unit 15b without storing the information in the storage unit 14.

The learning unit 15b learns the generation model representing a distribution of a probability that the data x in the task s is generated so that the mutual information amount between the latent variable and the observed variable is minimized in the generation model, This mutual information amount is a predetermined mutual information amount I(O; Z) having, as an upper bound, an expected value R(φ) of the Kullback-Leibler information amount KL for a variational lower hound L of a logarithm of the probability distribution.

Specifically, the learning unit 15b creates a generation model representing a distribution of a probability that the data x in the task s is generated, in Equation (1) above, based on the CVAE. In this case, the learning unit 15b learns the generation model so that the mutual information amount I(O; Z) in Equation (5) above is minimized. I(O; Z) is minimized instead of R(φ) in this manner, so that the task dependency can be further reduced as compared with the CVAE.

Further, the learning unit 15b estimates I(O; Z) by using density ratio estimation. The density ratio estimation is a scheme for estimating a density ratio (difference) of two probability distributions without estimating each of the two probability distributions.

Here, as expressed in Equation (5) above. WO is an expected value of the Kullback-Leibler information amount KL for the variational lower bound L of the logarithm of the probability distribution in Equation (3) above, and is an upper bound of the mutual information amount I(O; Z). Thus, the learning unit 15b estimates the difference between R(φ) and I(O; Z) by using the density ratio estimation.

Specifically, the learning unit 15b estimates the difference between R(φ) and I(O; Z) using a neural network TΨ(φ), as expressed in Equation (11) below. It is known that the difference between R(φ) and I(O; Z) has a positive value.

[Math, 11]

D_{KL}(q₉₉(z)||p(z))≃ [symbol] _{qϕ(z)}[T_{Ψ}(z)] . . . (11)

Here, TΨ(φ) is a neural network that maximizes an objective function in Equation (12) below.

$$\begin{matrix}[ Math . 12 ] & \\ {max}_{ψ} {{q}_{ϕ} ( z )}_{} [ ln ( σ ( {T}_{ψ} ( z ) ) ) ] + {p ( z )}_{} [ ln ( 1 - σ ( {T}_{ψ} ( z ) ) ) ] & ( 12 )\end{matrix}$$

In this case, the mutual information amount I(O; Z) can be estimated by subtracting the difference estimated by Equation (11) above from the upper bound R(φ), as shown in Equation (13) below.

[Math. 13]

I(O; Z)≃ [symbol] _{pD}(x,s) [D_{KL}(q₉₉(z|x,s)||p(z))]− [symbol] _{qϕ(z)}[T₁₀₅(z)] . . . (13)

The learning unit 15b substitutes the estimated mutual information amount I(O; Z) into an objective function F_{CVAE}(θ, φ) of the CVAE in Equation (4) above to obtain an objective function F_{Proposed}(θ, φ) of the present embodiment in Equation (14) below.

[Math. 14]

[symbol]

_{Proposed}(θ, φ)= [symbol] _{pD(x,s)}[ [symbol] (x, s; θ,ϕ)]+ [symbol] _{qϕ(z)}[T_{qϕ(z)}] . . . (14)

The learning unit 15b performs learning so that the objective function F_{Proposed}(θ, φ) is maximized to determine parameters. As expressed in Equation (14) above, the objective function F_{Proposed}(θ, φ) has a value greater by the difference in Equation (11) above than the objective function F_{CVAE}(θ, φ) in Equation (4) above. Thus, the learning unit 15b can estimate the probability distribution of the data x in the task s with higher accuracy than in the CVAE.

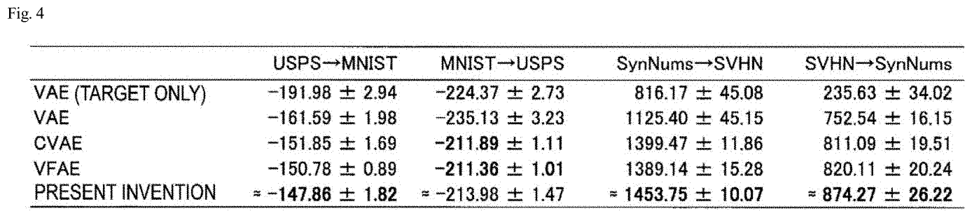

FIG. 4 is an illustrative diagram illustrating processing of the learning unit 15b. In FIG. 4, a log likelihood representing performance of a generation model learned by various schemes is illustrated. The log likelihood is a measure of accuracy evaluation of the generation model, and a greater value of the log likelihood indicates a higher accuracy. In various schemes illustrated in FIG. 4, all data in any of four types of data sets called USPS, MNIST, SynNums, and SYHN are used as sources, and 100 pieces of data in the data set are used as targets to perform learning. Further, performance of density estimation for target test data is evaluated.

In FIG. 4, four types of combinations of source→target including USPS→MNIST, MNIST→USPS, SynNums →SVHN, and SYHN→SynNums are illustrated. Further, in FIG. 4, application of VAE only to targets. VAE, CVAE, VFAE, and the present invention are illustrated as various schemes. VFAE is also an existing scheme.

As illustrated in FIG. 4, according to a scheme of the present invention, a value of the log likelihood is greater and the accuracy is higher than those of the other schemes except when an MNIST USPS data set is used. Thus, it can be seen that according to the scheme of the present invention, the accuracy of density estimation is generally improved as compared with the existing scheme. Thus, the learning unit 15b of the present embodiment can create a highly accurate generation model.

Configuration of Estimation Device

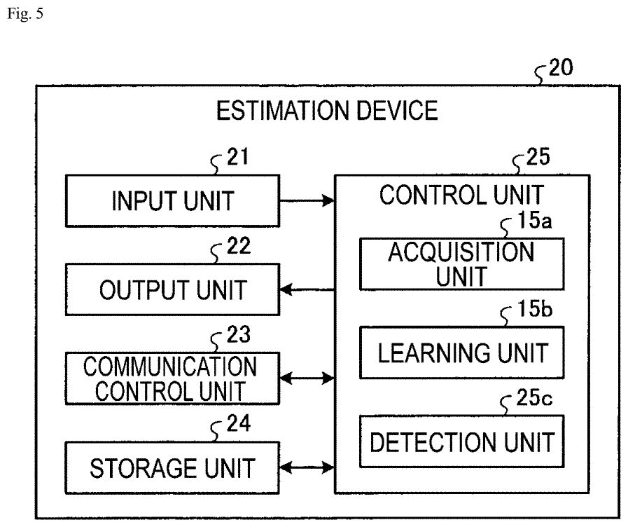

FIG. 5 is a schematic diagram illustrating a schematic configuration of the estimation device. As illustrated in FIG. 5, the estimation device 20 is achieved by a general-purpose computer such as a personal computer, and includes an input unit 21, an output unit 22, a communication control unit 23, a storage unit 24, and a control unit 25.

The input unit 21 is achieved by using an input device such as a keyboard or a mouse, and inputs various types of instruction information such as processing start to the control unit 25 in response to an input operation from the operator, The output unit 22 is achieved by a display device such as a liquid crystal display, a printing device such as a printer, or the like.

The communication control unit 23 is achieved by a network interface card (MC) or the like, and controls communication between an external device connected via a network, such as a server, and the control unit 25. For example, the communication control unit 23 controls communication between a management device or the like that manages various types of information and the control unit 15.

The storage unit 24 is achieved by a semiconductor memory element such as a random access memory (RAM) or a flash memory, or a storage device such as a hard disk or an optical disc, and stores, for example, a parameter of the data generation model learned by the learning device 10 described above. The storage unit 24 may be configured to communicate with the control unit 25 via the communication control unit 23.

The control unit 25 is achieved by using a central processing unit (CPU) or the like, and executes a processing program stored in a memory. This allows the control unit 25 to function as the acquisition unit 15a, the learning unit 15b, and the detection unit 25c, as illustrated in FIG. 5. All or some of these functional units may be implemented in different hardware. For example, the acquisition unit 15a and the learning unit 15b may be implemented in different hardware from the detection unit 25c. That is, the learning device 10 described above and the estimation device 20 including the detection unit 25c may be separate devices.

Because the acquisition unit 15a and the learning unit 15b are the same functional units as the learning device 10 described above, description thereof will be omitted.

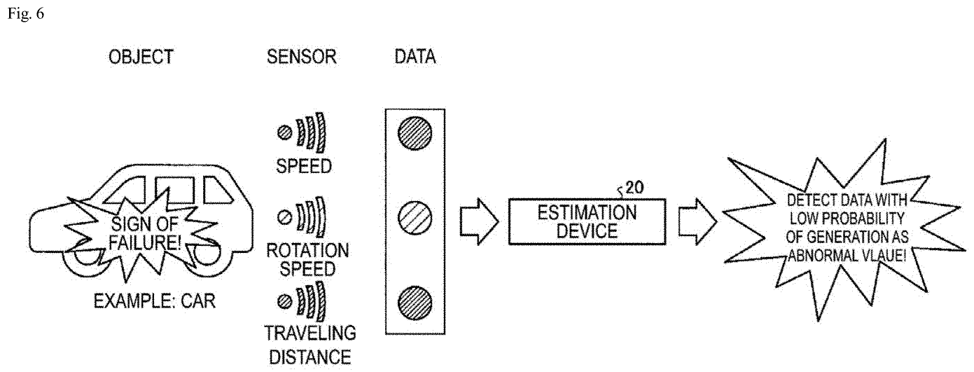

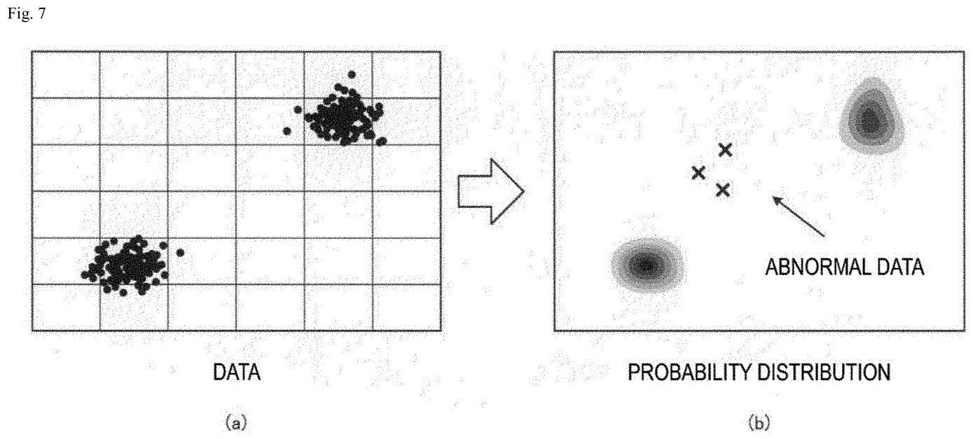

The detection unit 25c estimates a probability that newly acquired data in the task is generated, using the learned generation model, and detects an abnormality when the generation probability is lower than a predetermined threshold value. For example, FIGS. 6 and 7 are illustrative diagrams illustrating processing of the detection unit 25c. As illustrated in FIG. 6, in the estimation device 20, the acquisition unit 15a acquires, for each task, data of sensors for speed, rotation speed, traveling distance, and the like attached to an object such as a car, and the learning unit 15b creates a generation model representing the probability distribution of the data.

Further, the detection unit 25c uses the created generation model to estimate the distribution of the probability that the data in the task newly acquired by the acquisition unit 15a is generated. Further, the detection unit 25c determines a normality when the estimated probability that the data in the task newly acquired by the acquisition unit 15a is generated is equal to or more than the predetermined threshold value, and determines an abnormality when the estimated generation probability is lower than the predetermined threshold value.

For example, as illustrated in FIG. 7(a), when data indicated by points in a two-dimensional data space is given, the detection unit 25c uses the generation model created by the learning unit 15b to estimate a probability distribution of data generation, as illustrated in FIG. 7(b). In FIG. 7(b), a darker color in the data space indicates that a probability of data. generation is high in such a portion. Thus, data with a low probability of generation indicated by x in FIG. 7(b) can be regarded as abnormal data.

As described above, the generation model created by the learning unit 15b has low task dependency and can estimate the data generation probability with high accuracy independently of the task. Thus, the detection unit 25c can detect abnormal data with high accuracy.

Further, the detection unit 25c outputs an alarm when the abnormality has been detected. For example, the detection unit. 25c outputs a message or an alarm indicating abnormality detection to the management device or the like via the output unit 22 or the communication control unit 23,

Learning Processing

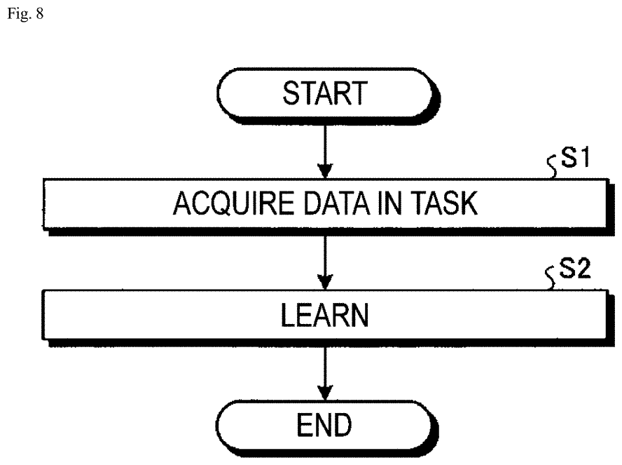

Next, learning processing of the learning device 10 according to the present embodiment will be described with reference to FIG. 8. FIG. 8 is a flowchart illustrating a learning processing procedure. The flowchart of FIG. 8 is started, for example, when an instruction of starting the learning processing is input.

First, the acquisition unit 15a acquires the data in the task (step S1). For example, the acquisition unit 15a acquires, for each task, data of sensors for speed, rotation speed, traveling distance, and the like attached to an object such as a car.

Then, the learning unit 15b learns the generation model representing the distribution of the probability that the data x in the task s is generated so that the mutual information amount between the latent variable and the observed variable is minimized in the generation model (step S2), This mutual information amount is a mutual information amount I(O; Z) having, as the upper bound, the expected value R(φ) of the Kullback-Leibler information amount KL for the variational lower bound L of the logarithm of the probability distribution. Specifically, the learning unit 15b creates the generation model representing the distribution of the probability that the data x in the task s is generated based on the CVAE, and learns the generation model so that the mutual information amount I(O; Z) is minimized.

In this case, the learning unit 15b estimates I(O; Z) by using the density ratio estimation. Further, the learning unit 15b performs learning so that the objective function F_{Proposed}(θ, φ) obtained by substituting the estimated mutual information amount I(O; Z) into the objective function F_{CVAE}(θ, φ) of the CVAE is maximized, to determine the parameter of the generation model. Thus, the series of learning processing ends.

Estimation Processing

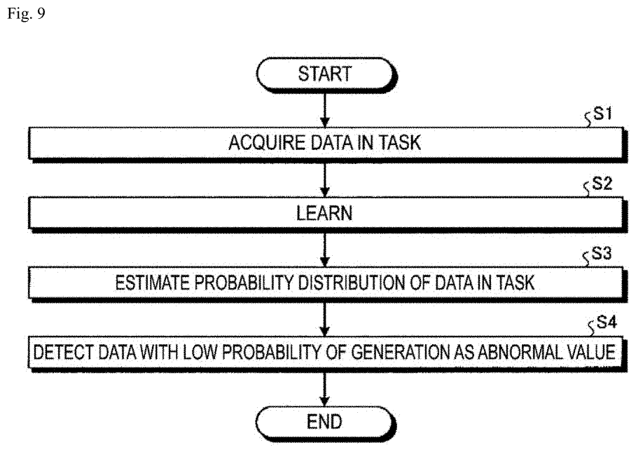

Next, estimation processing in the estimation device 20 according to the present embodiment will be described with reference to FIG. 9. FIG. 9 is a flowchart illustrating an estimation processing procedure. As illustrated in FIG. 9, processing operations of steps S1 to S2 are the same as the learning processing of the learning device 10 illustrated in FIG. 8, and thus description thereof will be omitted.

The detection unit 25c uses the created generation model to estimate the distribution of the probability that the data in the task newly acquired by the acquisition unit 15a is generated (step S3). Further, the detection unit 25c determines a normality when the estimated probability that the data in the task newly acquired by the acquisition unit 15a is generated is equal to or more than the predetermined threshold value, and determines an abnormality when the estimated probability of the data generation is lower than the predetermined threshold value (step S4). The detection unit 25c outputs an alarm when the detection unit 25c detects the abnormality. Thus, the series of estimation processes ends.

As described above, in the learning device 10 of the present embodiment, the acquisition unit 15a acquires the data in the task. Further, the learning unit 15b learns the generation model representing the distribution of a probability that the data in the task is generated so that the mutual information amount between the latent variable and the observed variable is minimized in the generation model. The mutual information amount is a predetermined mutual information amount having, as the upper bound, the expected value of the Kullback-Leibler information amount for the variational lower bound of the logarithm of the probability distribution. Further, this generation model includes an encoder that encodes data to convert the data into a representation using a latent variable, and a decoder that decodes the data encoded by the encoder, and is generated based on the CVAE.

Thus, the learning device 10 can reduce the task dependency and estimate the distribution of the probability that the data in the task is generated with higher accuracy. Thus, according to the learning device 10, it is possible to improve the accuracy of multitask learning.

Further, the learning unit 15b estimates the mutual information amount by using density ratio estimation. This allows the learning device 10 to efficiently reduce the task dependency of the generation model.

Further, in the estimation device 20 of the present embodiment, the acquisition unit 15a, acquires the data in the task. Further, the learning unit 15b learns the generation model representing the distribution of a probability that the data in the task is generated so that the mutual information amount between the latent variable and the observed variable is minimized in the generation model. Further, the detection unit 25c uses the teamed generation model to estimate the probability that the newly acquired data in the task is generated, and detects an abnormality when the probability of generation is lower than the predetermined threshold value. This allows the estimation device 20 to estimate the data generation probability with high accuracy independently of the task and detect the abnormal data with high accuracy through multitask learning.

For example, the estimation device 20 can acquire a large number of large-scale and complicated data output by various sensors for temperature, speed, rotation speed, traveling distance, and the like attached to a car, and detect an abnormality occurring in a traveling car with high accuracy. Alternatively, the estimation device 20 can acquire, for each task, large-scale and complicated data output by sensors for temperature, frequency, sound, and the like attached to a wide variety of devices operating in a factory, and detect an abnormality with high accuracy independently of the task when an abnormality occurs in any of the devices.

Further, the detection unit 25c outputs an alarm when the detection unit 25c has detected an abnormality. This allows the estimation device 20 to notify a notification destination capable of dealing with the detected abnormality so that the abnormality is dealt with.

The learning device 10 and the estimation device 20 of the present embodiment are not limited to those based on the CVAE of the related art. For example, processing of the learning unit 15b may be based on processing obtained by adding conditions of a task to an autoencoder (AE), which is a special case of VAE, or the encoder and the decoder may follow a probability distribution other than the Gaussian distribution.

Program

It is also possible to create a program in which the processing executed by the learning device 10 and the estimation device 20 according to the embodiment is described in a language that can be executed by a computer. In an embodiment, the learning device 10 can be implemented by a learning program that executes the learning processing being installed as package software or online software on a desired computer. For example, the information processing device is caused to execute the learning program so that the information processing device can function as the learning device 10. Similarly, an estimation program that executes the above estimation processing is installed on a desired computer so that the information processing device can function as the estimation device 20. The information processing device referred to herein includes a desktop type or notebook type personal computer. In addition, examples of the information processing device include a smartphone, a mobile communication terminal such as a mobile phone or a personal handyphone system (PHS), and a slate terminal such as a personal digital assistant (PDA). Further, functions of the learning device 10 or functions of the estimation device 20 may be implemented in a cloud server.

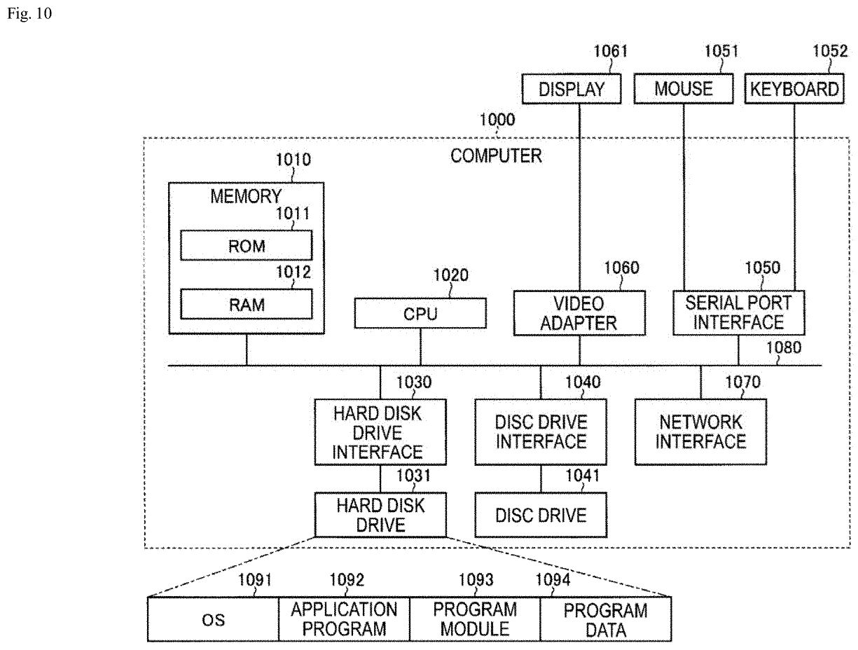

FIG. 10 is a diagram illustrating an example of a computer that executes the learning program or the estimation program. A computer 1000 includes, for example, a memory 1010, a CPU 1020, a hard disk drive interface 1030, a disc drive interface 1040, a serial port interface 1050. a video adapter 1060, and a network interface 1070. These units are connected by a bus 1080,

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disc drive interface 1040 is connected to the disc drive 1041. A removable storage medium such as a magnetic disk or an optical disc is inserted into the disc drive 1041. A mouse 10.51 and a keyboard 1052. for example, are connected to the serial port interface 1050. A display 1061, for example, is connected to the video adapter 1060.

Here, the hard disk drive 1031 stores, for example, an OS 1091, an application program 1092, a program module 1093, and program data 1094. Each piece of information described in the above embodiment is stored in, for example, the hard disk drive 1031 or the memory 1010.

Further, the learning program or the estimation program is stored in the hard disk drive 1031 as, for example, the program module 1093 in which commands executed by the computer 1000 are described. Specifically, the program module 1093 in which each processing executed by the learning device 10 or the estimation device 20 described in the above embodiment is described is stored in the hard disk drive 1031.

Further, data used for information processing in the learning program or the estimation program is stored as the program data 1094 in, for example, the hard disk drive 1031. The CPU 1020 reads the program module 1093 or the program data 1094 stored in the hard disk drive 1031 into the RAM 1012 as necessary, and executes each of the above-described procedures.

The program module 1093 or the program data 1094 related to the learning program or the estimation program is not limited to a case in which the program module 1093 or the program data 1094 are stored in the hard disk drive 1031, and for example, the program module 1093 or the program data 1094 may be stored in a removable storage medium and read by the CPU 1020 via the disc drive 1041 or the like. Alternatively, the program module 1093 or the program data 1094 related to the learning program or the estimation program may be stored in another computer connected via a network such as local area network (LAN) or wide area network (WAN) and read by the CPU 1020 via the network interface 1070.

Although the embodiment to which the invention made by the present inventor is applied has been described above, the present invention is not limited by the description and the drawings which constitute a part of the disclosure of the present invention according to the present embodiment. That is, other embodiments, examples, operation technologies, and the like made by those skilled in the art based on the present embodiment are all included in the scope of the present invention.

### Reference Signs List

10 Learning device

11, 21 Input unit

12, 22 Output unit

13, 23 Communication control unit

14, 24 Storage unit

15, 25 Control unit

15a Acquisition unit

15b Learning unit

20 Estimation device

25c Detection unit

1. A learning device, comprising:
acquisition circuitry configured to acquire data in a task; and
learning circuitry configured to learn a model representing a distribution of a probability that the data in the task is generated so that a mutual information amount between a latent variable and an observed variable is minimized in the model.

2. Currently Amended) The learning device according to claim 1 wherein:
the mutual information amount is a predetermined mutual information amount haying, as an upper bound, an expected value of a Kullback-Leibler information amount for a variational lower bound of a logarithm of the probability distribution.

3. The learning device according to claim 1, wherein:
the model includes an encoder configured to encode data to convert the data which has been encoded by the encoder into a representation using the latent variable, and a decoder configured to decode the data encoded by the encoder.

4. The learning device according to claim 1, wherein:
the learning circuitry estimates the mutual information amount by using density ratio estimation.

5. An estimation device, comprising:
acquisition circuitry configured to acquire data in a task;
learning circuitry configured to learn a model representing a distribution of a probability that the data in the task is generated so that a mutual information amount between a latent variable and an observed variable is minimized in the model; and
detection circuitry configured to estimate a probability that newly acquired data in a task is generated using the learned model and detect an abnormality when a probability of generation is lower than a predetermined threshold value.

6. The estimation device according to claim 5, wherein:
the detection circuitry outputs an alarm when the detection unit detects an abnormality.

7. A learning method executed by a learning device, the learning method comprising:
acquiring data in a task; and
learning a model representing a distribution of a probability that the data in the task is generated so that a mutual information amount between a latent variable and an observed variable is minimized in the model.

8. (canceled)

9. The learning method according to claim 7, wherein:
the mutual information amount is a predetermined mutual information amount having, as an upper bound, an expected value of a Kullback-Leibler information amount for a variational lower bound of a logarithm of the probability distribution.

10. The learning method according to claim 7, wherein:
the model includes an encoder configured to encode data to convert the data into a representation using the latent variable, and a decoder configured to decode the data encoded by the encoder.

11. The learning device according to claim 7, wherein:
the learning estimates the mutual information amount by using density ratio estimation.
